(19) United States
(12) Patent Application Publication
(10) Pub. No.: US 2026/0290184 A1
(43) Pub. Date: Sep. 24, 2026

(54) SYSTEMS AND METHODS FOR ASSISTING VERBAL COMMUNICATION IN REAL-TIME WITH ADAPTIVE FEEDBACK, HEARING-DEVICE INTEGRATION AND OUTCOME-BASED LEARNING

(71) Applicant: Hiroki SATO, Copenhagen (DK)

(72) Inventor: Hiroki SATO, Copenhagen (DK)

(21) Appl. No.: 19/684,590

(22) Filed: May 21, 2026

Related U.S. Application Data
(63) Continuation-in-part of application No. 17/909,622, filed on Mar. 4, 2020, now Pat. No. 12,646,421.

(51) Int. Cl. G09B 5/04; G06F 3/16; G10L 15/02; G10L 15/04; G10L 21/02; G10L 25/60

(52) U.S. Cl. CPC G09B 5/04; G06F 3/165; G10L 15/02; G10L 15/04; G10L 21/02; G10L 25/60

(57) ABSTRACT

A system and method for assisting verbal communication receives a live audio or audio-visual conversation stream, segments the stream into interaction units within a latency-bounded processing window, extracts acoustic, semantic, behavioral, user-interface, device, environmental, and network features, and detects communication-difficulty events. The system may compute contextual coherence metrics, affective risk metrics, and composite conversational risk metrics, generate speaker-directed and listener-directed assistance, render real-time overlays or prompts, enable replay/save/clarification support for corresponding audio blocks, store structured interaction event records with integrity metadata, and update listener-specific thresholds or model parameters based on post-modification outcomes. Additional embodiments include a meeting-to-hearing-device bridge for synchronizing difficult-segment metadata and audio blocks with hearing devices, cochlear implants, and companion applications, and an assistive replay and rehabilitation workflow that provides personalized playback, rehabilitation summaries, and consent-governed remote-care or clinician review.

### FIELD OF INVENTION

The invention relates generally to speech, audio, audio-visual signal processing, hearing devices, and communication-assistance systems. More specifically, the disclosure relates to systems and methods for improving conversational intelligibility by detecting communication-difficulty events, generating real-time feedback, supporting assistive replay, and adapting listener-specific parameters based on outcomes.

### BACKGROUND

Digital communication platforms, telephony systems, mobile devices, hearing devices, and audio-visual meeting systems increasingly mediate interactions in professional, educational, clinical, assistive-hearing, and daily conversational settings. Conventional hearing assistance and communication systems often focus on signal enhancement, such as adjustment of speech speed, pitch, frequency, gain, directionality, beamforming, noise suppression, or other audio processing techniques.

Although such techniques may improve signal clarity, they do not by themselves ensure that conversational content is understood. Communication breakdowns may arise from excessive speech rate, high filler-word usage, interruptions, unclear turn taking, semantic misalignment between a question and an answer, failure to address a specific question, affective escalation, cognitive fatigue, language-proficiency mismatch, accent related intelligibility differences, or environmental and network impairments.

Listeners may not explicitly request clarification because of social constraints, conversational dynamics, fatigue, delayed recognition of misunderstanding, or the desire not to interrupt. Accordingly, misunderstanding may persist even when an audio signal is technically audible.

There is a need for systems that extend beyond conventional audio signal enhancement by performing cross domain signal inference, generating real-time speaker-directed and listener-directed assistance, storing structured event records, supporting replay of difficult segments, bridging meeting platforms with hearing device ecosystems, and adapting listener-specific thresholds and model parameters based on measured outcomes.

### SUMMARY

The present invention relates to computer-implemented conversation-assistance system receives a live audio communication stream associated with an ongoing conversation between one or more participants. The system segments the live audio communication stream into a plurality of interaction units and extracts one or more feature sets from each interaction unit, including acoustic features, semantic features, behavioral features, user-interface interaction features, device-state features, environmental features, and network-condition features. Based at least in part on the extracted feature sets, the system generates a communication-difficulty score and/or a composite conversational risk metric corresponding to each interaction unit.

In some embodiments, the system determines one or more contextual coherence metrics for a current interaction unit by comparing a representation of the current interaction unit with one or more prior interaction-unit representations maintained in a context buffer. The contextual coherence metrics may include, without limitation, a topic-alignment score, a question-answer relevance score, a semantic continuity score, and/or a divergence score. The system may further generate one or more reason tags indicative of a detected conversational divergence condition, including, for example, off-topic content, non-responsive content, semantic mismatch, abrupt topic shift, incomplete explanation, clarification need, or emotional escalation.

In some embodiments, the system determines one or more affective-state indicators and/or escalation-risk indicators using acoustic signals, linguistic signals, and behavioral signals associated with the live conversation stream. An affective risk vector may be combined with semantic divergence metrics and acoustic intelligibility metrics to generate the composite conversational risk metric.

In some embodiments, responsive to determining that a trigger condition has been satisfied, the system generates a conversational modification instruction and causes rendering of a real-time assistance interface. The assistance interface may include, without limitation, a visual overlay, popup notification, side-panel interface, haptic notification, wearable-device prompt, smart-glasses prompt, hearing-device prompt, or companion-application interface. The conversational modification instruction may direct a speaker to slow speech, summarize content, provide an example, answer more directly, rephrase content, acknowledge an emotional state, confirm listener understanding, or perform another conversational repair action. Listener-directed assistance may include replay controls, save controls, explanatory aids, caption support, clarification prompts, confirmation prompts, or visual explanatory content associated with a corresponding audio block.

In some embodiments, segmentation, feature extraction, scoring, trigger evaluation, and user-interface rendering are performed within a latency-bounded processing window while the conversation remains ongoing. The latency-bounded implementation may be configured to provide speaker-facing guidance and/or listener-facing assistance prior to a subsequent conversational turn, thereby enabling real-time intervention during a live communication session rather than post-session analysis.

In some embodiments, one or more listener-specific decision parameters are determined based on a hearing profile, calibration data, prior replay activity, prior save activity, response-latency history, device characteristics, rehabilitation-program data, and/or user preference data. A trigger condition may be determined using a combination of semantic divergence metrics, acoustic intelligibility features, affective-state indicators, behavioral indicators, and listener-specific decision parameters such that an intervention strategy is adapted to a particular listener, speaker-listener pair, device type, deployment environment, or communication context.

In some embodiments, speaker-facing and listener-facing user interfaces are independently controlled. A speaker-facing interface may present a conversational repair instruction and one or more associated reason tags, while a listener-facing interface may provide replay functionality, save functionality, clarification assistance, confirmation assistance, or explanatory support associated with a corresponding interaction unit or audio block. The interfaces may be rendered by a conferencing client, companion application, wearable interface, smart-glasses interface, hearing-device ecosystem interface, or distributed client-cloud architecture.

In some embodiments, the system generates and stores a structured interaction-event record associated with one or more interaction units. The interaction-event record may include identifiers, timestamps, extracted feature sets, threshold values, weighting parameters, reason tags, modification strategy identifiers, rendered instruction data, outcome metrics, privacy-state indicators, model-version identifiers, audio-block references, replay indicators, save indicators, and/or integrity metadata. Integrity protection may include event hashing, hash chaining, redundant storage, trusted timestamping, and/or distributed-ledger anchoring.

In some embodiments, a meeting-to-hearing-device bridge communicatively couples a conferencing platform with one or more hearing devices, cochlear implants, companion applications, or assistive listening systems. The bridge may synchronize audio blocks, segment identifiers, timestamps, conversational risk outputs, listener-specific thresholds, and assistance prompts between the conferencing platform and the hearing-device ecosystem.

In some embodiments, an assistive replay and rehabilitation workflow stores audio blocks associated with difficult conversational segments and provides replay and save functionality for subsequent review. Playback parameters, including playback speed, pitch, and/or volume, may be adjusted according to a listener hearing capability, hearing profile, or user preference. The workflow may further generate rehabilitation summaries and selectively route consent-governed summaries to remote-care systems, clinician systems, rehabilitation providers, or caregiver workflows.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 illustrates a system architecture including audio input, a conversation analysis engine, memory/storage, user interfaces and optional network/cloud services, according to some embodiments.

FIG. 2 presents an illustration of conversation segmentation into interaction units with timestamps and metadata, according to some embodiments.

FIG. 3 illustrates an implicit difficulty signals taxonomy including interaction signals, response-pattern signal, acoustic signals, UI/device signals, and environment/network signals, according to some embodiments.

FIG. 4 illustrates signal fusion and confidence generation comprising a signal vector, listener-calibrated weights and thresholds, confidence score generation, and an event trigger, according to some embodiments.

FIG. 5 illustrates an enhanced conversation repair protocol including confidence or risk scoring, listener specific and context-adjusted threshold comparison, cumulative risk evaluation, event classification, contextual evaluation, repair strategy selection, repair execution, outcome monitoring, and a feedback loop to profiles, weights, thresholds, and models, according to some embodiments.

FIG. 6 illustrates an enhanced difficulty event record data structure including segment identifiers, participant and device identifiers, feature sets, risk metrics, thresholds and weights, reason tags, modification strategy identifiers, outcome metrics, privacy or consent state, model version identifiers, corresponding audio-block pointers, replay/save indicators, and integrity metadata, according to some embodiments.

FIG. 7 illustrates an enhanced tamper-resistant evidence framework including canonicalized event records, event hashes, hash chaining, dual local and remote storage, trusted timestamping or optional ledger anchoring, and verification by recomputing and comparing stored hash values, according to some embodiments.

FIG. 8 illustrates a cross accent or multilingual profile for pairwise intelligibility risk scoring and tailored repair actions, according to some embodiments.

FIG. 9 illustrates a contextual coherence and topic alignment analysis module including a current interaction unit, prior context units, a context buffer or conversation memory, a semantic feature extractor, an alignment scoring engine, a divergence detector, and a coherence metrics output with reason tags, according to some embodiments.

FIG. 10 illustrates an affective state inference and emotion escalation detection module including a multimodal emotion model, risk vector builder, composite risk metric generator, cross-domain fusion layer, dynamic decision engine, and decision trigger, according to some embodiments.

FIG. 11 illustrates a speaker-directed real-time feedback and conversational modification subsystem including a decision trigger, modification strategy selector, delivery channel controller, feedback message generator, conversational modification executor, and post-modification monitor, according to some embodiments.

FIG. 12 illustrates a learning and adaptation module configured to update listener-specific parameters, context dependent offsets, fusion weights, model parameters, strategy-selection policies, and structured event records based on post-modification outcomes, according to some embodiments.

FIG. 13 illustrates a meeting-to-hearing-device bridge architecture including a conferencing client, bridge controller, companion application, hearing device and/or cochlear implant, communication link, listener specific profile, device UI/prompt router, and optional remote-care or clinician interface, according to some embodiments.

FIG. 14 illustrates an assistive replay, rehabilitation summary, and clinician workflow arrangement including difficult-segment detection, corresponding audio-block storage, replay and save controls, playback personalization, outcome and rehabilitation metrics, rehabilitation summaries, consent/privacy gating, and optional remote-care workflow triggers, according to some embodiments.

### DETAILED DESCRIPTION

The following description provides example embodiments and is not intended to limit the claims. The disclosed components may be implemented as hardware, software, firmware, cloud services, edge-device processing, hearing-device processing, companion-device processing, or distributed combinations thereof. Although figures are described separately for clarity, features of different embodiments may be combined unless the context indicates otherwise.

Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. Ranges from any lower limit to any upper limit are contemplated. The upper and lower limits of these smaller ranges which may independently be included in the smaller ranges is also encompassed within the disclosure, subject to any specifically excluded limit in the stated range. Where the stated range includes one or both of the limits, ranges excluding either both of those included limits are also included in the disclosure.

Although any methods and materials similar or equivalent to those described herein can also be used in the practice or testing of the present disclosure, the preferred methods and materials are now described. All publications mentioned herein are incorporated herein by reference to disclose and described the methods and/or materials in connection with which the publications are cited.

It must be noted that as used herein and in the appended claims, the singular forms “a”, “and”, and “the” include plural references unless the context clearly dictates otherwise.

Unless otherwise defined, all technical and scientific terms used herein have the same meaning as commonly understood by one of ordinary skill in the art to which this disclosure belongs. The terminology used in the description of the disclosure herein is for describing particular embodiments only and is not intended to be limiting of the disclosure. All publications, patent applications, patents, figures and other references mentioned herein are expressly incorporated by reference in their entirety.

The present disclosure relates to systems and methods for enhancing conversation during live interactions. In some examples the invention provides a communication-assistance system configured to detect communication-difficulty events in real time based on audio and contextual signals, and to provide targeted assistance to one or more participants. The system may deliver speaker-directed prompt to improve clarity and listener-directed assistance to enhance comprehension, while continuously adapting based on interaction history. The disclosed techniques may be implemented across various platforms, including meeting systems, telephony applications, mobile devices, and assistive listening technologies.

As used herein, a conversation may include a dialog, multi-party discussion, meeting, call, classroom interaction, contact-center session, clinical interaction, telehealth session, hearing-device interaction, or other exchange of speech or textual content. The interaction may occur in real time or near real time and may be in person, remote, hybrid, synchronous, or partially asynchronous.

As used herein, an interaction unit may include a sentence, phrase, utterance, speaker turn, sub-utterance, time window, semantic segment, caption segment, translated segment, or other time-bounded portion of an interaction. A communication-difficulty event may refer to a detected condition in which a listener is likely to have difficulty understanding the speech, the content, the speaker intent, the relationship between a response and a question, or the emotional state or interaction flow of the conversation.

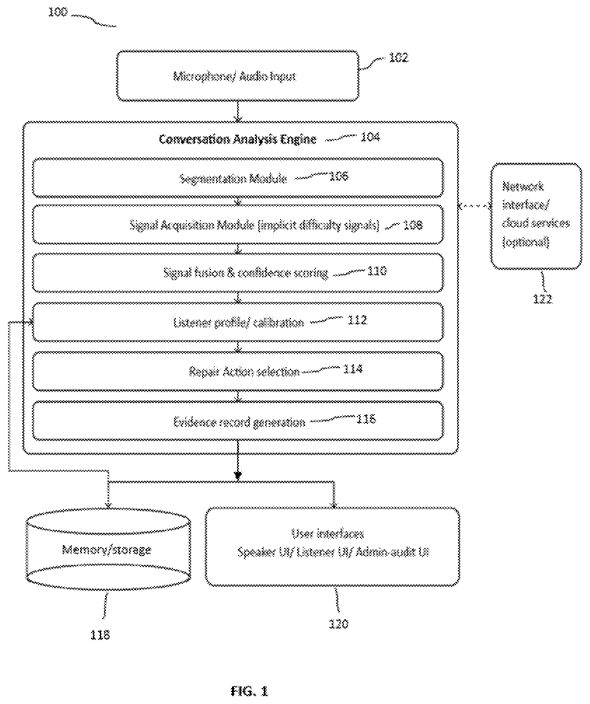

FIG. 1 illustrates a system architecture 100. One or more microphones or audio inputs 102 receive speech signals from one or more sources. The input source may include a device microphone, hearing-device microphone array, cochlear-implant accessory microphone, meeting-platform audio stream, telephone audio stream, or other audio or audio-visual source.

The audio input 102 is operatively coupled to a conversation analysis engine 104, which processes the received conversation to detect and respond to communication-difficulty events.

Within the conversation analysis engine 104, the received audio is first processed by a segmentation module 106, which partitions the conversation stream into segments or interaction units. The segmented data is then provided to a signal acquisition module 108, which extracts heterogeneous signals (implicit difficulty signals), including acoustic, behavioral, response-pattern, UI/device, and contextual environmental/network signals from the interaction. The extracted signals are further processed by a signal fusion and confidence scoring module 110, which combines multiple signals to generate a confidence score indicative of a communication-difficulty event.

In some embodiments, a segment may correspond to a sentence, phrase, utterance, short time window, or other portion of a live interaction. The system may determine that a segment is associated with a communication-difficulty event based on acoustic features, linguistic features, interaction features, contextual features, behavioral features, or combinations thereof.

The signal fusion and confidence scores 110 and associated signals are provided to a listener profile and calibration module 112, which applies listener-specific parameters, thresholds, or learned preferences. Based on the calibrated output, a repair action selection module 114 determines an appropriate intervention strategy. The selected action is then recorded by an evidence record generation module 116, which creates structured records of detected events and corresponding system responses.

The conversation analysis engine 104 may further interface with a network interface and/or cloud services 122 to enable extended processing, storage, or model updates. Outputs from the conversation analysis engine 104 are provided to a storage component 118 to one or more user interfaces 120, including a speaker interface, a listener interface, and/or an administrative or audit interface, for real-time feedback and interaction.

In some embodiments, the conversation is not limited to a dialog, multi-party discussion, meeting, or call, and may include any form of interaction comprising speech and/or textual content exchanged between at least one speaker and at least one listener. Such interactions may occur in real-time or asynchronously, and may be conducted through in-person communication, telephony systems, messaging platforms, conferencing applications, or other communication environments.

In some embodiments, the live conversation stream is received as a live audio or audio-visual stream from a microphone, hearing-device microphone array, cochlear-implant interface, companion device, conferencing client, telephony endpoint, or other audio interface. The conversation analysis engine may be configured to process the stream in a latency-bounded manner so that repair prompts, replay controls, save controls, clarification controls, or explanatory aids are presented while the corresponding conversation remains actionable.

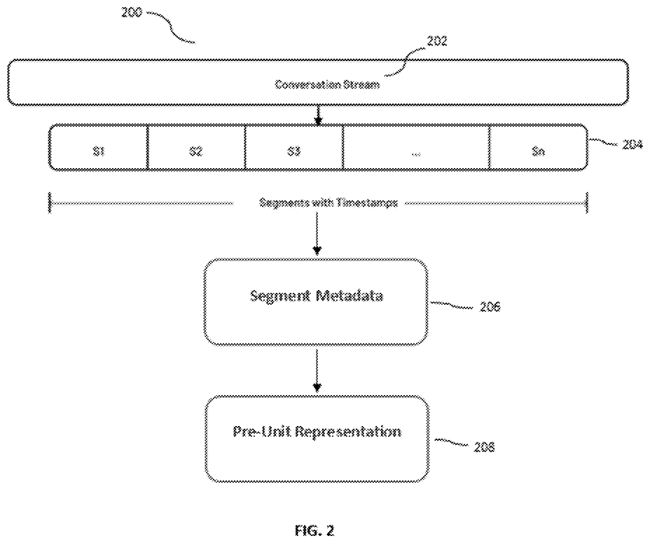

Referring to FIG. 2, a conversation segmentation unit 200 is configured to receive conversation stream 202 corresponding to one or more participants engaged in an interaction. The conversation stream 202 may comprise audio data obtained from one or more input sources and is processed to generate a plurality of discrete segments (S1, S2, S3 . . . . Sn), each segment representing a respective interaction unit within the conversation. The segmentation unit 200 may use time-based windowing, pause detection, voice activity detection, speaker diarization, speaker-turn detection, semantic boundary detection, caption boundaries, translated text boundaries, or combinations thereof. Each interaction unit may include audio-derived features, semantic representations, or both.

Each of the plurality of interaction units is associated with one or more timestamps 204, which may define a start time, an end time, and/or a duration, speaker identifier, listener identifier, device identifier, environment identifier, network identifier, speaker turn order, overlap indicators, response latency, and other metadata 206 corresponding to the segment. The timestamps enable temporal ordering and alignment of the segments within the conversation stream 202, thereby facilitating downstream processing, event detection, and contextual analysis.

The conversation segmentation unit 200 further generates segment metadata 206 for each interaction unit. The segment metadata 206 may include, by way of example and without limitation, a speaker identifier corresponding to the participant generating the speech, a listener identifier corresponding to one or more intended recipients, and an environment and/or network identifier indicative of contextual conditions such as device type, acoustic environment, communication channel, or network quality. In some embodiments, the metadata may further include interaction attributes such as speaker turn order, overlap indicators, or response latency.

Each interaction unit generated by the conversation segmentation unit 200 comprises at least per unit representations 208 that is audio-derived data and semantic representation data. The audio-derived data may include acoustic features such as amplitude, pitch, speech rate, prosody, and spectral characteristics extracted from the audio signal. The semantic representation data may include intent representations, topic representations, keyword sets, embeddings, summaries and/or other semantic features derive from speech transcriptions, recognized text or direct semantic encoders capturing the meaning and contextual relationships of the spoken content. In certain implementations, semantic representations may be derived using speech recognition and natural language processing models.

The conversation segmentation unit 200 may be operatively coupled to a control module or processing engine configured to regulate segmentation parameters dynamically based on interaction context, speaker behavior, or system policies. The conversation segmentation unit 200 provides structured, time-aligned interaction units enriched with metadata and semantic information, thereby enabling downstream modules to perform accurate detection of communication-difficulty events and to support adaptive conversational assistance.

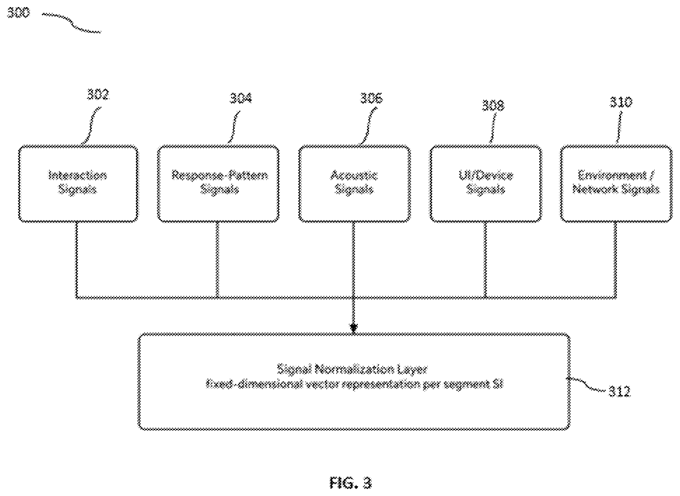

Referring to FIG. 3, an implicit difficulty signal domains 300 comprises multiple heterogeneous signal domains configured to detect communication-difficulty events. The taxonomy includes, without limitation, interaction signals 302, response-pattern signals 304, acoustic signals 306, user interface (UI) and/or device signals 308, and environment and/or network signals 310. These signal domains are processed through a signal normalization layer 312, which converts domain-specific signals into a unified computational representation space. The normalized signals may thereafter be independently or collectively analyzed to infer difficulty conditions during an interaction.

In some embodiments, the normalized vectors may include, by way of example, Mel-frequency cepstral coefficients (MFCCs), prosodic contours, speech rate measures, response latency distributions, interruption frequency, subtitle toggle frequency, rewind frequency, codec change indicators, and network jitter values.

Each signal category may be mapped into a fixed-dimensional vector representation associated with a corresponding segment Si, thereby enabling consistent downstream processing and fusion across heterogeneous signal domains.

The interaction signals 302 may be associated with participant interaction behavior during a communication session. The interaction signals 302 may include, without limitation, interruptions, repeated clarification requests, turn-taking anomalies, conversational overlap events, incomplete responses, repeated prompts, explicit manual difficulty indications, participant hesitation patterns, or other interaction-level indicators suggesting reduced communication effectiveness or comprehension difficulty.

The response-pattern signals 304 associated with temporal and semantic characteristics of conversational responses. The response-pattern signals 304 may include delayed responses, mismatched replies, repeated answers, non-responsiveness, response latency variations, topic inconsistencies, semantic divergence between conversational turns, acknowledgment failures, repeated confirmations, or other conversational-response anomalies indicative of communication difficulty or contextual misunderstanding.

The acoustic signals 306 may be derived from conversation streams associated with the interaction and may include, for example, signal-to-noise ratio (SNR) estimates, pitch contours, speech rate measurements, energy and/or intensity levels, and spectral features. Such acoustic features may be indicative of speech clarity, background noise conditions, or speaker delivery characteristics that affect comprehension.

The UI and/or device signals 308 may be generated based on user interactions with a device or interface. These signals may include, for example, activation or toggling of subtitles, replay or rewind events, volume adjustments, playback speed modifications, or other user-initiated controls indicative of comprehension difficulty.

The environment and/or network signals 310 may reflect external conditions affecting the interaction. These signals may include codec changes, packet loss, bandwidth fluctuations, latency measurements, jitter measurements, channel-state indicators, room-noise classifications, reverberation estimates, microphone quality indicators, wireless signal conditions, background-environment classifications, device channel state information, and/or other network or environmental parameters capable of affecting conversational clarity or communication quality.

The normalized vectors are processed through a feature embedding layer implemented within signal fusion and confidence scoring module 400.

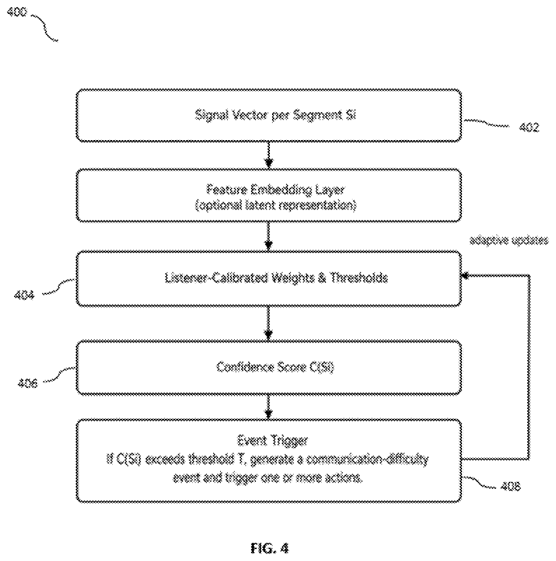

Referring to FIG. 4, a signal fusion and confidence generation framework 400 operates on a per-segment basis, wherein, for each interaction segment Si, a signal vector 402 is generated. The signal vector 402 may be formed from normalized features derived from multiple heterogeneous signal domains, including acoustic, behavioral, response-pattern, user interface, and environment-related signals, as described with reference to FIG. 3.

In some examples, the signal vector 402 may further be processed through a feature embedding layer to generate a latent representation capturing cross-domain relationships among the input signals. The embedding layer may include one or more machine learning models, such as a neural projection network, a recurrent neural network, a transformer encoder, a convolutional temporal encoder, or a graph-based model, thereby extending the signal vector into a learned representation space.

The signal vector 402, or the corresponding embedded representation, is then provided to a weights and thresholds module 404. The module 404 applies listener-calibrated weights and/or thresholds to the input features. In some embodiments, the weights may be predefined, learned, or dynamically updated based on listener-specific thresholds, interaction history, environmental context, or speaker-listener pair characteristics.

In some examples, the listener-specific threshold may include, but is not limited to, thresholds derived from calibration data, learned personalization parameters, or listener profile attributes (e.g., hearing profile, language proficiency, cognitive fatigue sensitivity).

The weighted and processed signals are used to compute a confidence score C(Si) 406 for the segment Si. The confidence score C(Si) 406 represents a measure of the likelihood that a communication-difficulty event is associated with the segment.

The confidence score C(Si) 406 is compared against a threshold T within an event trigger module 408. When the confidence score exceeds the threshold T, a communication-difficulty event is generated, and one or more corresponding actions are triggered. Such actions may include, without limitation, initiating a repair strategy, generating feedback for one or more participants, or logging a structured interaction event record.

In some embodiments, the threshold T and/or weighting parameters may be dynamically adjusted based on contextual factors, listener-specific calibration, or adaptive feedback mechanisms. The event trigger 408 may further contribute to downstream decision-making processes, enabling real-time and personalized intervention within the communication system.

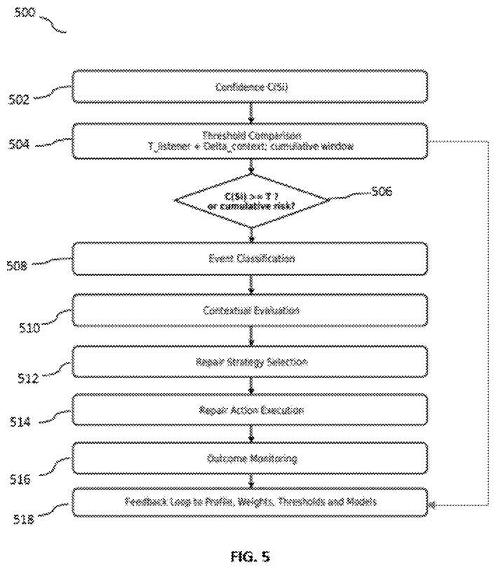

Referring to FIG. 5, an enhanced conversation repair protocol 500 is illustrated for detecting, evaluating, and mitigating communication difficulty conditions occurring during an interaction session. In various embodiments, the protocol 500 may be implemented by one or more conversational assistance engines, adaptive communication systems, hearing-assistance systems, wearable devices, cloud-based processing platforms, or distributed processing architectures configured to monitor conversational interactions in substantially real time

At step 502, a confidence score or composite intelligibility risk metric associated with a segment Si. The confidence score C(Si) and/or composite risk metric R(Si) may be generated based on one or more acoustic features, semantic features, behavioral indicators, contextual parameters, environmental conditions, and/or multimodal interaction signals associated with the corresponding segment. In certain embodiments, the score may represent a predicted probability or likelihood of communication difficulty, misunderstanding, reduced intelligibility, conversational breakdown, or user assistance requirement.

At step 504, the obtained score is compared with one or more thresholds to determine whether a conversational repair action should be initiated. The threshold comparison may incorporate a listener-specific threshold T_listener, a context-dependent adjustment or offset Δ_context, and/or a cumulative risk threshold evaluated across multiple interaction units within a temporal window. In certain implementations, a repair trigger condition may occur when:

C(Si)>T_listener+Δ_context
or

when a cumulative risk metric associated with a plurality of segments exceeds a cumulative threshold.

ΣC(Si-k . . . Si)>T_cumulative

If the threshold condition is not satisfied, corresponding to the “No”, the system 100 may continue passive monitoring of subsequent interaction units without initiating a repair action. In such embodiments, the system may continuously update risk metrics, contextual information, and monitoring parameters while maintaining ongoing observation of the conversational interaction.

If the threshold condition is satisfied, corresponding to the “Yes”, the protocol proceeds to step 508, wherein a detected communication event is classified. The event classification may identify one or more categories associated with the detected communication difficulty. By way of example and not limitation, classifications may include acoustic degradation, excessive speech rate, semantic ambiguity, semantic mismatch, topic shift, non-responsiveness, behavioral mismatch, affective escalation, emotional distress indicators, environmental impairment, network impairment, or multimodal conversational instability.

At step 510, the system 100 performs contextual evaluation associated with the detected event. The contextual evaluation may incorporate one or more contextual factors including speaker profile information, listener profile information, accent profile data, language proficiency indicators, domain-specific terminology familiarity, conversational agenda context, environmental conditions, device characteristics, historical interaction behavior, prior repair outcomes, and/or previously detected communication patterns. In certain embodiments, the contextual evaluation enables adaptive personalization of subsequent repair actions according to participant characteristics and interaction conditions.

Further, based on the classification and contextual evaluation, a repair strategy 512 is selected. The repair strategy selection 512 may be implemented by a conversational modification engine, which may include one or more components such as a neural paraphrasing model, a prosody adjustment controller, an interaction flow optimizer, a confirmation-step generator, and/or a clarification question generator. The selected strategy is designed to mitigate the identified communication difficulty.

In some examples but not limited to, the selected repair strategy may include instructing a speaker to slow down, provide a summary, provide an example, define a term, clarify ambiguous content, directly answer a question, reduce speech complexity, rephrase content, pause before continuing, acknowledge an emotional condition, insert a confirmation step, or otherwise modify conversational delivery characteristics.

At the repair action execution stage 514, the selected repair strategy is applied to modify the ongoing interaction. Such modification may include altering content representation (e.g., simplification or paraphrasing), adjusting delivery parameters (e.g., speech rate, pitch, or volume), modifying turn-taking behavior, or introducing confirmation or clarification steps. The repair action may be delivered via an overlay interface, popup notification, haptic cue, wearable-device prompt, smart-glasses interface, hearing-device ecosystem, companion application, visual transcription interface, audio-processing subsystem, or other adaptive communication-assistance channel. In certain embodiments, the repair action may be selectively directed toward a speaker, listener, moderator, or external assistive device associated with the interaction.

At step 516, outcome monitoring is performed following execution to evaluate the effectiveness of the applied repair action. The monitoring process may analyze subsequent conversational signals and interaction metrics to determine whether communication quality has improved. Such monitored indicators may include improved topic alignment, improved semantic relevance between questions and responses, reduced response latency, reduced repetition requests, reduced conversational interruptions, reduced affective-risk indicators, reduced composite-risk values, decreased replay or rewind interactions, reduced subtitle dependence, or other measurable interaction-quality metrics.

At step 518, The feedback loop utilizes the monitored outcomes to update system parameters and models. In some embodiments, the system supports online adaptation through mechanisms such as incremental gradient updates, reinforcement learning, policy-gradient optimization, or listener-specific fine-tuning. Updates may be triggered based on improvements in communication effectiveness, including reduced mismatch probability or enhanced listener comprehension.

The feedback loop 518 may further update listener-specific profiles and calibration parameters including thresholds, weights, and decision policies. In this manner, the system establishes a closed-loop adaptive architecture that continuously refines signal fusion, decision-making, and repair strategies across interactions.

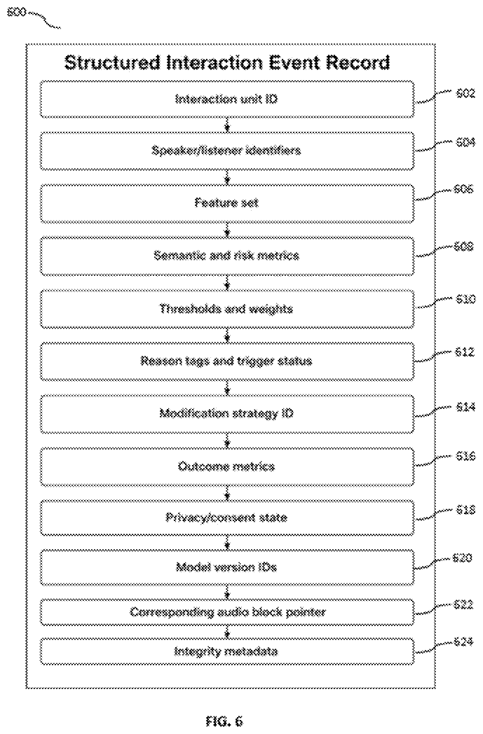

Referring to FIG. 6, difficulty event record data structure 600 stores the support analysis of communication difficulty events detected during conversation interaction.

In some embodiments, the difficulty event record data structure 600 stores a structured interaction event record and a corresponding audio block associated with a current interaction unit or conversation segment. The structured interaction event record may permit a listener to replay, save, bookmark, or review the associated audio block.

In some embodiments, one or more playback parameters associated with the audio block may be adjusted according to a listener profile, hearing capability, rehabilitation program, accessibility preference, device profile, or contextual communication condition. Such playback parameters may include playback speed, playback pitch, playback volume, caption presentation, subtitle presentation, explanatory-aid presentation, or combinations thereof.

The difficulty event record 600 may include a segment identifier and/or timestamp field 602, which uniquely associates the record with a specific interaction unit or segment Si. The segment identifier may correspond to a turn, utterance, or sub-utterance unit, while the timestamp may indicate the temporal position of the segment within the interaction timeline, thereby enabling temporal sequencing and alignment with other conversational signals.

The difficulty event record 600 may further include an identifier field 604 storing one or more participant and session identifiers associated with the interaction unit. The identifier field 604 may include a speaker identifier, listener identifier, session identifier, device identifier, communication-channel identifier, environment identifier, network identifier, application identifier, or combinations thereof. Such identifiers facilitate contextual association of conversational events with corresponding participants, devices, communication sessions, and operating environments.

A feature set 606 may store one or more extracted or derived features associated with the segment. Such features may include acoustic features (e.g., signal-to-noise ratio, pitch variance), linguistic features (e.g., syntactic complexity, token entropy), semantic representations (e.g., embedding vectors or hashes), and/or behavioral indicators (e.g., interruption frequency, response latency). In some embodiments, the feature set may further include composite intelligibility or conversational risk metrics computed for the segment.

In some embodiments, The semantic features stored within the feature set 606 may include keywords, topic representations, intent representations, semantic embeddings, embedding hashes, summaries, contextual descriptors, question-answer relevance scores, topic alignment scores, divergence scores, semantic mismatch indicators, token entropy metrics, syntactic complexity indicators, and/or other semantic or linguistic representations generated using speech-recognition and natural-language-processing models.

In some embodiments, the behavioral and user-interface signals stored within the feature set 606 may include response latency values, interruption indicators, replay actions, save actions, subtitle toggling events, playback-control changes, wearable-device interactions, hearing-device program changes, device-control modifications, manual difficulty indications, and/or other interaction-behavior indicators associated with conversational assistance or communication difficulty.

The difficulty event record 600 may further include a semantic and risk metrics field 608. The semantic and risk metrics field 608 may store topic-alignment scores, question-answer relevance scores, semantic divergence metrics, intelligibility scores, affective-risk indicators, behavioral-risk indicators, and/or composite conversational risk metrics computed for the corresponding interaction unit.

A thresholds and weights 610 may record the decision parameters applied at the time of event detection. These parameters may include listener-specific thresholds, context-adjusted thresholds, cumulative risk thresholds, and weighting coefficients used in signal fusion or scoring functions. Storing such parameters enables reproducibility of decision conditions and supports post hoc analysis and model calibration.

A reason tag 612 may include the inferred cause or classification of the communication-difficulty event. Reason tags may correspond to predefined divergence categories such as off-topic, non-responsive, topic-shift, semantic-mismatch, acoustic degradation, or behavioral misalignment. In some embodiments, multiple reason tags may be assigned to a single event, optionally with associated confidence scores or hierarchical relationships.

A modification strategy and repair-action field 614 may specify one or more conversational modification strategies selected in response to the detected event. The field 614 may include modification-strategy identifiers, selected repair actions, rendered instructions, explanatory aids, delivery-channel identifiers, listener-directed assistance, speaker-directed prompts, replay indicators, save indicators, or combinations thereof.

In some embodiments, the repair actions may include paraphrasing, simplification, repetition, clarification prompts, confirmation prompts, speech-rate adjustment instructions, prosody modifications, example generation, sentence restructuring, turn-taking modifications, or related conversational repair operations.

An outcome metrics 616 may capture post-modification signals indicative of the effectiveness of the applied repair strategy. These metrics may include changes in response latency, reduction in repetition or clarification requests, improvements in semantic alignment scores, updated confidence or risk metrics, and/or user feedback indicators. In some embodiments, outcome metrics may be computed over a defined temporal window following the repair action.

A consent and privacy state 618 may record user-specific permissions. Such attributes may include consent flags, data retention policies, anonymization status, and access control indicators, thereby ensuring compliance with privacy requirements and enabling selective use of the recorded data for training or analysis.

In certain embodiments, the difficulty event record 600 may further incorporate structured interaction event attributes, including interaction unit identifiers, composite conversational risk metrics, modification strategy identifiers, model version identifiers, semantic embedding hashes, applied threshold values, and post-modification improvement metrics. These elements support consistency with logging-dependent claims and enable robust tracking of system behavior across model versions and deployment contexts.

The difficulty event record 600 may further include a model and calibration metadata field 620 storing model-version identifiers, calibration references, training provenance information, update history, deployment identifiers, and/or system-configuration metadata associated with conversational inference operations. Such information enables tracking of conversational analysis behavior across different model versions and deployment contexts.

In certain embodiments, the difficulty event record 600 may further include a corresponding audio-block pointer 622 associated with replay and playback operations. The audio-block pointer 622 may include pointers to locally stored or remotely stored audio blocks, replay indicators, save indicators, playback-parameter settings, caption settings, explanatory-aid settings, and/or listener-specific playback configurations associated with the corresponding interaction segment.

In some embodiments, the difficulty event record 600 may further include a replay/save indicator field 624. The replay/save indicator field 624 may store one or more indicators corresponding to user-initiated or system-suggested replay and save actions associated with the interaction segment. Such indicators may include replay triggers, replay counts, partial or full segment replay markers, save flags, bookmark identifiers, highlight regions, or combinations thereof. The replay/save indicator field 624 may enable enhanced tracking of listener engagement, facilitate adaptive playback assistance, support personalized learning or rehabilitation workflows, and provide additional behavioral signals for refining conversational difficulty detection and repair strategies.

The difficulty event record 600 may additionally include an integrity metadata field 626 configured to provide integrity verification and tamper-resistance functionality. The integrity metadata field 626 may include an event hash, previous-event hash, chain hash, secure timestamp token, local storage identifier, remote storage identifier, ledger identifier, blockchain anchor identifier, remote anchor identifier, and/or related cryptographic verification metadata. In certain embodiments, cryptographic hashing and chained-record structures may be used to preserve integrity, traceability, and auditability of stored conversational records.

Accordingly, the data structure 600 provides a comprehensive and extensible representation of communication-difficulty events, enabling detailed analysis, auditability, and continuous refinement of conversational models and repair strategies within the adaptive interaction framework.

In some embodiments, the difficulty event record data structure 600 is stored in local device storage, remote server storage, or both, and may be secured using cryptographic hashing and hash chaining to ensure integrity and tamper resistance. The structured records may be exposed, in whole or in part, via an application programming interface that provides access to conversational risk outputs including divergence scores, affective risk vectors, composite risk metrics, reason tags, modification strategy identifiers, trigger status, threshold values, and outcome metrics.

In some embodiments, the system stores an event record associating a flagged segment with one or more difficulty signals, a selected speaker-directed repair action, a selected listener-directed assistance, replay behavior, subsequent listener interaction, or combinations thereof. The event record may be used to update a listener-specific profile, a speaker-specific profile, a topic-domain profile, an environment-specific profile, or a device-specific profile.

In some embodiments, the system generates a speaker-specific intelligibility or coaching profile indicating when a speaker's speech is likely to be difficult for one or more listeners or listener-profile categories. The profile may be based on speech speed, pitch transitions, volume, monotonicity, vocabulary, sentence length, topic shifts, listener replay behavior, listener clarification behavior, prompt effectiveness, and post-intervention outcome signals.

The system may use the speaker-specific profile to adapt future speaker-directed repair actions, reduce repeated actions, provide training analytics, create gamified or coaching-based feedback, or generate accessibility training reports

In some embodiments, the communication-difficulty event for a time-bounded segment causes asymmetric outputs to different participants. A speaker may receive a speaker-directed repair action, while a listener may receive a listener-directed assistance action associated with the same segment.

In some embodiments, the speaker-directed repair action may refer to but not limited to any instruction, prompt, signal, or feedback presented to a speaker to improve understandability, such as an instruction to slow down, use simpler wording, define a term, add structure, provide an example, shorten a sentence, pause, or rephrase.

The speaker-directed repair prompt may be presented as haptic feedback, aural feedback, visual feedback, a popup card, overlay, side panel, graphical indicator, textual instruction, coaching interface, or meeting-interface action. The action may instruct the speaker to slow down, speak more clearly, adjust volume, vary pitch, simplify wording, define a term, provide an example, summarize, pause, answer directly, rephrase, reduce ambiguity, add structure, or confirm understanding.

In some embodiment, the visual feedback may include a concise instruction region, such as a message equivalent to ‘speak slowly’ or ‘provide an example,’ an explanatory or empathetic sentence region, and one or more controls for dismissing, acknowledging, clarifying, replaying, saving, or selecting a next action. The prompt may be designed so that the speaker receives a behavioral instruction without exposing a listener's identity, disability status, hearing profile, or private assistance profile unless permitted by consent

In some embodiments, the system uses one or more manual difficulty indications from a listener as direct evidence that a flagged segment was not understood. A manual difficulty indication may be received through a hardware button, a soft button in an application, a gesture detected by a wearable device, a touch command, or another user-interface control. A manual difficulty indication may trigger replay of a recent segment, saving of a recent segment, adjustment of a playback parameter, logging of the segment as difficult, updating of a listener-specific profile, generation of a speaker-directed repair action, generation of listener-directed assistance, or combinations thereof.

In some embodiments, the listener-directed assistance action may include replay or save indicators, a simplified paraphrase, a domain-term gloss, a tentative meaning hint, a recap, a confirmation prompt, caption fallback, translation fallback, visual explanatory aid indicator, or an instruction to replay or save a corresponding audio block.

In some embodiments, the acoustic features are evaluated in conjunction with one or more preset or default threshold values during an initial operation phase of the system. The preset thresholds may be applied when the system is first deployed for a listener and prior to the accumulation of sufficient listener-specific interaction data required to derive personalized threshold parameters.

Accordingly, the system is configured to operate in a cold-start mode, wherein conversational analysis, difficulty detection, or risk assessment is performed using generalized or population-level thresholds in the absence of listener-specific calibration. As interaction data is accumulated over time, the system may transition from the cold-start mode to a personalized mode by updating one or more threshold values based on listener-specific behavioral patterns, acoustic characteristics, or interaction outcomes, thereby improving accuracy and relevance of subsequent processing.

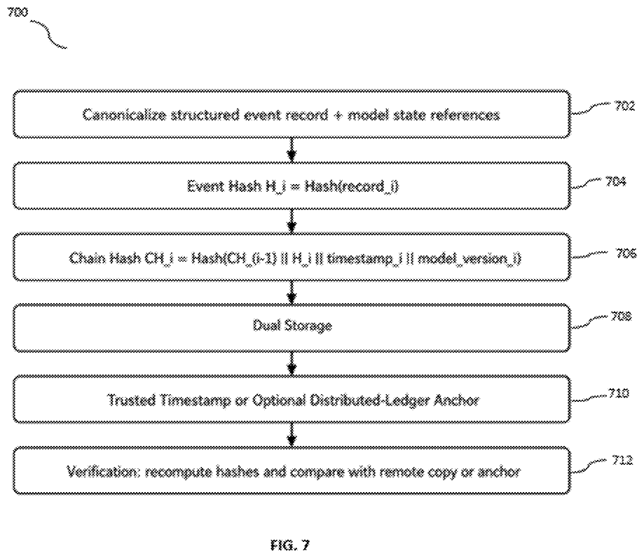

Referring to FIG. 7, a tamper-resistant evidence framework 700 ensures integrity, auditability, and reproducibility of recorded interaction events. The framework 700 may include one or more integrity mechanisms applied to the structured interaction event records.

At step 702, a structured interaction event record is canonicalized into a deterministic serialized representation. The canonicalization process may arrange selected fields according to a predefined ordering, encoding scheme, and formatting structure such that equivalent records produce substantially identical serialized outputs across multiple systems or verification operations.

In some embodiments, a structured interaction event record includes an interaction-unit identifier, timestamp, speaker identifier, listener identifier, device identifier, session identifier, acoustic feature set, semantic feature set, affective risk metric, composite risk metric, threshold value, fusion weight, reason tag, trigger status, repair strategy identifier, rendered instruction, listener-aid identifier, outcome metric, privacy or consent state, model version identifier, audio-block pointer, replay indicator, save indicator, or integrity metadata.

In some embodiments, the canonicalized representation may include event-record fields, timestamp metadata, model-version identifiers, threshold values, feature hashes, semantic representations, calibration references, repair-strategy identifiers, outcome metrics, consent metadata, and/or related conversational-analysis parameters associated with a corresponding interaction event.

The integrity metadata may include an event hash generated over a canonicalized event record, a chain hash linked to a previous event hash, a trusted timestamp, dual local and remote storage metadata, or optional ledger anchoring data. Verification may include recomputing and comparing one or more hash values

The tamper-resistant evidence framework 700 includes event hashes 704, wherein each structured interaction event record is processed using a cryptographic hashing function to generate a corresponding hash value representing the contents of the record. The event hash 702 serves as a compact integrity fingerprint of the recorded data. The framework further includes hash chaining 704, wherein each event hash is linked to a previous event hash to form a sequential chain of records.

In some embodiments, the event hash may be generated according to the following relationship:

H_i=Hash(record_i)

where record_i corresponds to the canonicalized structured interaction event record associated with an i-th conversational event. The hash operation may comprise a cryptographic hashing function configured to generate a deterministic and tamper-evident digest corresponding to the canonicalized event record.

At step 706, a chain hash CH_i is generated using the event hash H_i together with prior-chain information and model-state metadata.

In some embodiments, the chain hash may be generated according to the following relationship:

CH_i=Hash(CH_(i−1)∥H_i∥timestamp_i∥model_version_i)

where CH_(i−1) corresponds to a prior chain hash, H_i corresponds to the event hash associated with the current event, timestamp_i corresponds to a timestamp associated with the current event, and model_version_i identifies a model state, inference configuration, calibration state, or model version applied during conversational analysis or repair operations associated with the corresponding event.

In some embodiments, the chain-hash structure establishes sequential dependency among stored interaction records such that modification of an earlier event record invalidates one or more subsequently generated chain hashes. For example, modification of a first event hash H1 may invalidate subsequently generated chain hashes associated with H2, H3, and later-linked records, thereby enabling detection of tampering, corruption, unauthorized modification, record inconsistency, or model-state inconsistency.

At step 708, one or more event records, event hashes, chain hashes, or combinations thereof may be stored in one or more storage systems. The storage systems may include local device storage, companion-device storage, hearing-device ecosystem storage, wearable-device storage, remote server storage, cloud storage, distributed storage infrastructure, or combinations thereof. In certain embodiments, redundant storage mechanisms and/or geographically distributed storage architectures may be used to improve resilience, availability, synchronization reliability, and forensic recoverability of conversational evidence records.

At step 710, a trusted timestamp authority and/or an optional distributed-ledger anchor may record a creation timestamp, timestamp token, anchor value, or verification reference associated with one or more event records, event hashes, or chain hashes.

At step 712, verification operations are performed to validate integrity of one or more stored conversational evidence records. The verification operations may include re-canonicalizing one or more stored records, recomputing corresponding event hashes and chain hashes, and comparing recomputed values against locally stored values, remotely stored values, timestamp-authority values, anchored ledger values, or combinations thereof. In certain embodiments, detection of a mismatch between recomputed values and stored or anchored values may indicate tampering, corruption, unauthorized modification, incomplete synchronization, record inconsistency, or model-state inconsistency.

In some embodiments, the tamper-resistant evidence framework 700 further supports model-state validation and reproducible review of conversational decisions. For example, inclusion of model-version identifiers, calibration references, threshold parameters, inference-state metadata, and repair-strategy identifiers within canonicalized records enables subsequent reconstruction and auditing of conversational decisions, repair operations, risk scores, and adaptive assistance outputs generated during prior interactions.

In some embodiments, the framework 700 further enables audit-ready export of structured interaction evidence records for use in regulatory review, compliance validation, accessibility verification, dispute resolution, forensic analysis, clinical documentation, quality assurance, and/or machine-learning performance assessment. Exported evidence records may preserve cryptographic integrity metadata, conversational context references, replay associations, and inference-state traceability across multiple deployments, software versions, and model updates.

Accordingly, the tamper-resistant evidence framework 700 supports auditability, regulatory compliance, and secure validation of conversational analysis outputs in enterprise, clinical, or regulated deployment environments.

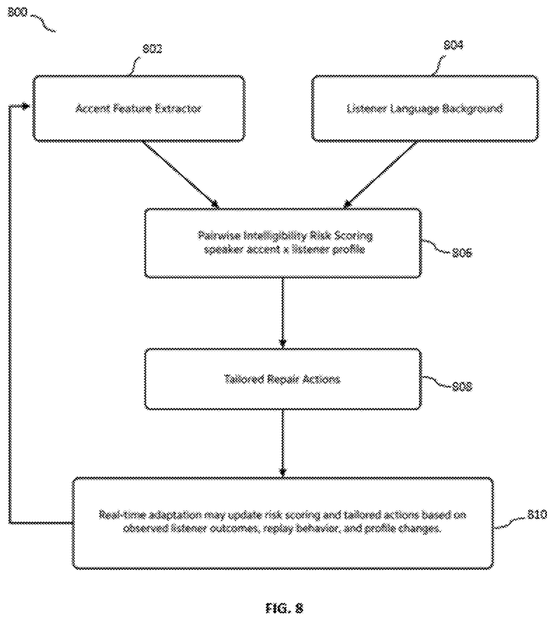

Referring to FIG. 8, a cross accent/multilingual profile 800 for generating listener-specific intelligibility risk assessments and corresponding tailored intervention strategies.

In some embodiments, the cross accent/multilingual profile 800 includes an accent feature extractor 802 configured to process one or more speech inputs and derive accent-related features, including phonetic patterns, prosodic characteristics, articulation tendencies, and other acoustic or linguistic markers associated with a speaker's accent profile.

In parallel, the cross accent/multilingual profile 800 accesses or determines a listener language background and/or proficiency profile 804. The listener profile may include one or more attributes such as primary language, secondary languages, proficiency levels, comprehension history, exposure to specific accents, or adaptive learning parameters derived from prior interactions. In some examples, the listener profile is dynamically updated based on observed comprehension outcomes or feedback signals.

The extracted accent features and the listener language background/profile are provided as inputs to a pairwise intelligibility risk scoring module 806. The module computes a listener-specific intelligibility risk score by evaluating the interaction between the speaker's accent characteristics and the listener's language proficiency and familiarity. The scoring may incorporate probabilistic models, learned embeddings, or weighted feature comparisons to estimate the likelihood of misunderstanding, reduced comprehension, or increased cognitive load for the listener.

Based on the computed intelligibility risk score, the cross accent/multilingual profile 800 determines and outputs one or more tailored repair actions 808. The tailored repair actions may include adaptive modifications such as adjusting speech rate, enhancing articulation clarity, rephrasing content, providing textual reinforcement, enabling captions, inserting clarification prompts, or selecting alternative communication strategies optimized for the listener's profile.

In certain embodiments, the pairwise intelligibility risk scoring and the selection of tailored repair actions are performed in real time during an ongoing interaction. The system may continuously update the risk assessment as additional speech input and listener response data are received, thereby enabling dynamic adaptation of intervention strategies.

In some embodiments, the outputs of the pairwise intelligibility risk scoring module 806 and the selected tailored repair actions 808 are recorded as part of structured interaction event records, enabling subsequent analysis, personalization refinement, and system optimization across diverse speaker-listener pairings.

In some embodiments, the tailored repair actions 808 may include simplified prompts, recap-confirm procedures, speech-rate guidance, articulation guidance, captioning assistance, explanatory aids, additional examples, or combinations thereof.

In some embodiments, interaction outcomes, replay behavior, comprehension indicators, or profile updates 810 may be monitored in real time to dynamically update the intelligibility risk score and modify the selected tailored repair actions 808. Structured interaction event records associated with the speaker-listener interaction may be generated and stored for subsequent adaptation, analytics, or refinement of speaker and listener profiles.

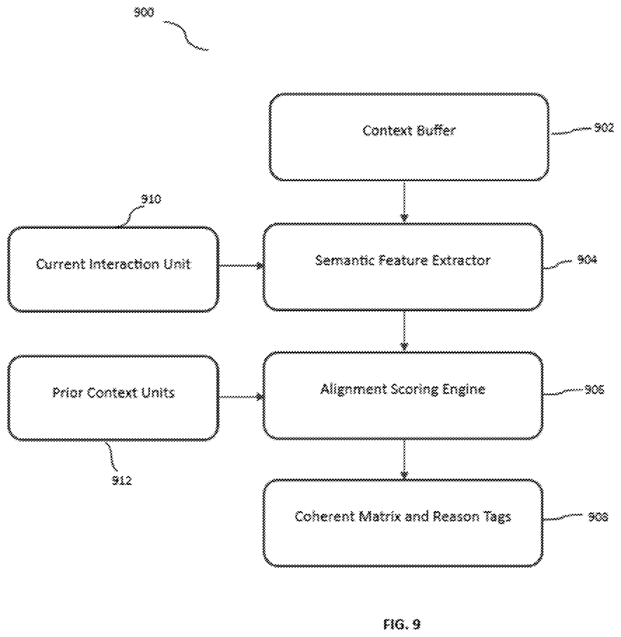

Referring to FIG. 9, a contextual coherence and topic alignment analysis module 900 is configured to evaluate whether a current interaction unit semantically aligns with prior conversational context and/or a preceding query.

The module operates on structured representations of the current interaction unit, including semantic embeddings, extracted keywords, and summary-level representations that capture the underlying intent and topical content.

To support this evaluation, one or more prior interaction units (k . . . i−1) are retrieved to represent the relevant conversational history against which the current interaction unit is assessed. These prior units provide contextual grounding, enabling the system to determine whether a response is coherent, relevant, and contextually appropriate.

A context buffer or conversation memory 902 is provided to store prior interaction-unit representations. The stored representations may include intent markers, topic indicators, keywords, semantic embeddings, and divergence history metrics or previously generated reason tags. The context buffer or conversation history 902 may be implemented as a sliding window retaining the most recent N interaction units and may be indexed based on speaker identity, listener identity, and/or environment or network context to support personalized and context-aware analysis and reduces semantic drift by enabling retrieval of prior context representations, improving contextual coherence detection accuracy.

A semantic feature extractor 904 processes the current interaction unit to derive machine-readable one or more semantic features representations enabling computational alignment scoring beyond acoustic measures.

In some embodiments, the extracted semantic features include at least: (i) an intent representation, (ii) a topic representation, and (iii) a semantic embedding vector. The semantic feature extractor 904 may be implemented using one or more models, including transformer-based embedding encoders, semantic retrieval models, textual entailment models, topic classifiers, or hybrid architectures combining multiple techniques.

The derived semantic features are provided to an alignment scoring engine 906, which computes similarity and alignment measures between the current interaction unit and at least one prior semantic representation retrieved from the context buffer 902. The alignment scoring engine 906 computes at least a topic alignment score and a question-answer relevance score, and may further compute a divergence score representing the degree of contextual deviation.

The scoring operations may be performed using one or more techniques, including cosine similarity between embedding vectors, learned alignment models, cross-attention similarity mechanisms, textual entailment evaluation, question-type matching, and/or hybrid symbolic-neural approaches. These methods collectively enable robust evaluation of both semantic similarity and contextual appropriateness.

A divergence detector 908 receives the computed scores and classifies one or more divergence conditions based on predefined thresholds T, learned criteria, or adaptive models. The divergence detector 908 generates at least one reason tag selected from a set including (off-topic, non-responsive, topic-shift, semantic-mismatch). For example, if the question-answer relevance score falls below a defined threshold, the system may assign a non-responsive tag, whereas a significant deviation in topic alignment relative to prior context may result in a topic-shift tag.

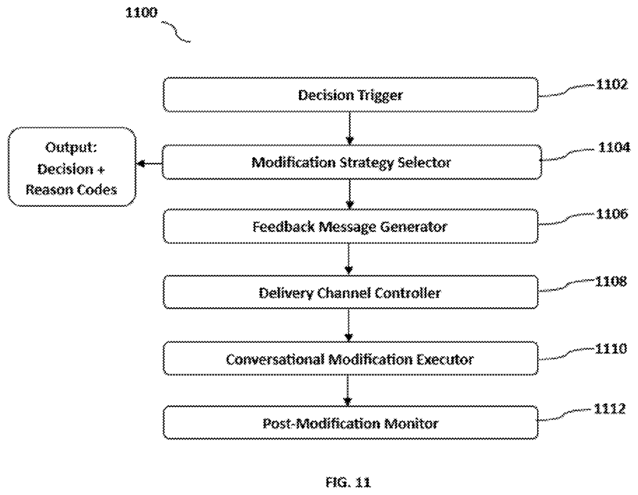

Then outputs coherence metrics 910, including one or more of the topic alignment score, question-answer relevance score, and divergence risk score. The generated reason tag(s) are included with the output and provided to a downstream decision layer, such as the speaker-directed feedback subsystem of FIG. 11 for further processing.

In some embodiments, semantic feature extraction is performed locally on a hearing device or a companion device configured to capture and process audio or conversational input in proximity to a user. In such embodiments, higher-level processing functions, including composite conversational risk computation, are performed remotely on a cloud server to leverage greater computational resources and centralized model inference capabilities.

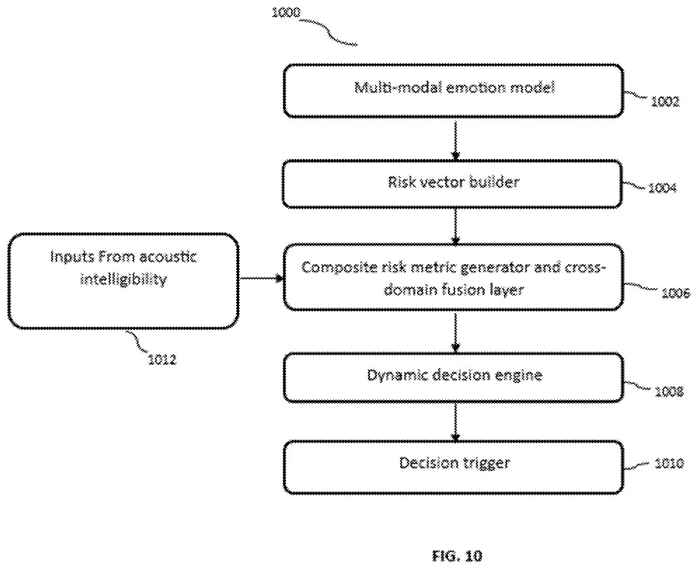

Referring to FIG. 10, an affective state inference and emotion escalation detection module 1000 is configured to infer one or more affective states of participants and to estimate escalation risk during an interaction. The module operates on multi-modal conversational signals and generates outputs used in composite conversational risk computation and downstream intervention triggering.

The affective state inference and emotion escalation detection module 1000 includes a multi-modal emotion model 1002, which processes heterogeneous inputs derived from one or more interaction segments Si. The inputs may include:
(a) acoustic and prosodic features, including pitch, intensity, speech rate, jitter, shimmer, and voice quality characteristics;
(b) linguistic markers, including sentiment polarity, frustration-related phrases, repeated negations, escalation indicators, and discourse-level cues; and
(c) behavioral signals, including repetition frequency, interruption patterns, response latency variations, overlap, and abrupt turn-taking changes.

The multi-modal emotion model 1002 may be implemented using one or more machine learning architectures, including recurrent neural networks, transformer-based encoders, multimodal fusion networks, or hybrid models combining acoustic and textual encoders. The model generates probabilistic outputs or confidence scores corresponding to one or more affective states, including frustration, confusion, anger, satisfaction, sadness, and escalation trajectories over time.

The outputs of the multi-modal emotion model 1002 are provided to a risk vector builder 1004, which constructs an affective risk vector representing the emotional and escalation state associated with the interaction segment. In some embodiments, the affective risk vector includes not limited to a frustration probability value, anger probability, confusion probability, stress indicator, sadness probability, satisfaction probability, and escalation probability.

In some examples, the affective risk vector is represented as:

R_affective=[P_frustration,P_escalation,S_stress]

where each component is a normalized score, probability, or learned representation derived from the outputs of the multi-modal emotion model 1002.

In certain embodiments, the affective state inference and emotion escalation detection module 1000 operates continuously on a per-segment basis and maintains temporal state information, enabling detection of affective trends, escalation trajectories, and persistent emotional states across multiple interaction units.

The affective risk vector is provided to a composite risk metric generator and cross-domain fusion layer 1006, which integrates multi-domain inputs to compute a composite conversational risk metric based a divergence score or coherence metric derived from the contextual coherence module 900 and one or more acoustic intelligibility or signal quality features acoustic or intelligibility outputs from FIG. 1-8,

The composite risk metric generator and cross-domain fusion layer 1006 may employ one or more fusion mechanisms, including weighted aggregation, attention-based fusion, gating networks, or learned neural fusion architectures, to combine the multi-domain inputs into a unified risk representation. In some embodiments, the fusion process incorporates listener-specific calibration parameters, such that weighting coefficients, feature sensitivities, or normalization schemes are adapted based on listener profiles, preferences, or historical interaction data.

The computed composite conversational risk metric is provided to a dynamic decision engine 1008, which evaluates whether one or more intervention conditions are satisfied. The dynamic decision engine 1008 compares the composite conversational risk metric against one or more thresholds, which may include listener-specific thresholds.

Upon satisfaction of one or more decision conditions, the dynamic decision engine 1008 generates a trigger signal indicative of a communication-difficulty or escalation event at decision trigger module 1010. The decision trigger module 1010 is configured to receive and consolidate inputs including the composite conversational risk metric, affective risk outputs, coherence metrics, and one or more associated reason tags corresponding to divergence conditions.

The decision trigger module 1010 determines whether to initiate a speaker-directed intervention based on the received trigger signal and associated contextual parameters.

In some embodiments, the cross-domain fusion layer is implemented and executed within a cloud computing environment, wherein multi-modal signals received from one or more client devices are aggregated and processed to generate a unified composite conversational risk metric. The resulting outputs are transmitted back to a client device, where a user interface overlay is rendered to provide real-time feedback, guidance, or intervention instructions to a user.

Referring to FIG. 11, a speaker-directed real-time feedback and conversational modification subsystem receives the intelligibility risk outputs, coherence metrics and reason tags from FIG. 9, and affective risk outputs from FIG. 10, and proceeds to a decision trigger 1102, and may generate a decision and reason codes, such as topic shift, non-responsive, listener confusion likely, speaking too fast, too ambiguous, escalation risk, or acoustic degradation.

A modification strategy selector 1104, which is configured to select at least one modification strategy based on one or more conversational modification strategies, reason tags, listener profile, context, speaker-listener pair history, acoustic difficulty, semantic mismatch, and affective escalation. Example strategies include providing a short summary, providing a concrete example, answering a question directly, inserting a confirmation step, reducing ambiguity, rephrasing, slowing speech rate, inserting a pause, acknowledging emotion, or de-escalating phrasing. The modification strategy selector 1104 may implement rule-based selection, learned policy models, or hybrid approaches to determine an appropriate intervention strategy.

In some embodiments, the selected modification strategy includes one or more actions such as reducing speech rate, providing a summary, introducing an example, confirming question alignment, reducing ambiguity, inserting a confirmation step, or modifying interaction flow.

The selected modification strategy is provided to a feedback message generator 1106, which generates one or more speaker-directed guidance messages corresponding to the selected strategy. The feedback message generator 1106 may utilize predefined templates, dynamically generated text, or machine learning-based natural language generation models to produce contextually relevant and actionable guidance.

The generated messages are tailored based on the associated reason tag(s) and the decomposition of the composite risk metric, enabling differentiation between divergence-related issues and affective escalation conditions. Example messages may include “Try giving a one-sentence summary and one example,” “Confirm what the question is asking, then answer directly,” “You may be speaking too fast,” or “Tone escalation detected-try calmer phrasing.”

Following delivery of the guidance, the guidance is provided to a delivery channel controller user interface (UI Integration) 1108, which is configured to render a user interface overlay on a display device in real time during the interaction. The delivery channel controller user interface (UI Integration) 1108 may support multiple presentation modalities, including overlays within video conferencing interfaces, companion application interfaces, wearable devices, or augmented reality display systems.

In some embodiments, role-based privacy policies may restrict certain prompts to a speaker, listener, moderator, clinician, or administrator.

The user interface overlay presents at least: (i) the speaker-directed modification instruction, and (ii) one or more associated reason tags corresponding to detected divergence or communication-difficulty conditions. In some embodiments, the overlay may further include visual indicators, confidence levels, or contextual cues to enhance interpretability and usability.

In some examples, when a reliability measure, confidence score, or fallback-trigger condition satisfies a predefined threshold, the system determines a fallback state and causes a real-time overlay, popup window, or side panel to be rendered in one or more user interfaces associated with a speaker, listener, moderator, interpreter, bilingual reviewer, or companion application. The rendered interface may present one or more of: a conversational modification instruction, a clarification prompt, a language selection prompt, a key-term confirmation prompt, or an explanatory indication of the detected communication-difficulty condition.

The output is provided to a conversational modification executor 1110, which is configured to implement and refine one or more modification actions applied during interaction.

The conversational modification executor 1108 may execute actions including confirmation gating, recap or summary generation, speech rate adjustment or pause insertion, ambiguity reduction through clarification prompts, and insertion of confirmation steps within the interaction flow.

The process then proceeds to a post-modification monitor 1112, which is configured to evaluate the effectiveness of the applied intervention. The post-modification monitor 1112 analyzes subsequent interaction units to measure one or more monitored outcome signals, including improvements in semantic alignment, reduction in response latency, decrease in repetition or clarification requests, and reduction in affective escalation indicators.

The monitored outcome signals include, but are not limited to, improvements in semantic alignment, reduction in response latency, reduction in repetition or clarification requests, and stabilization or reduction in affective escalation indicators.

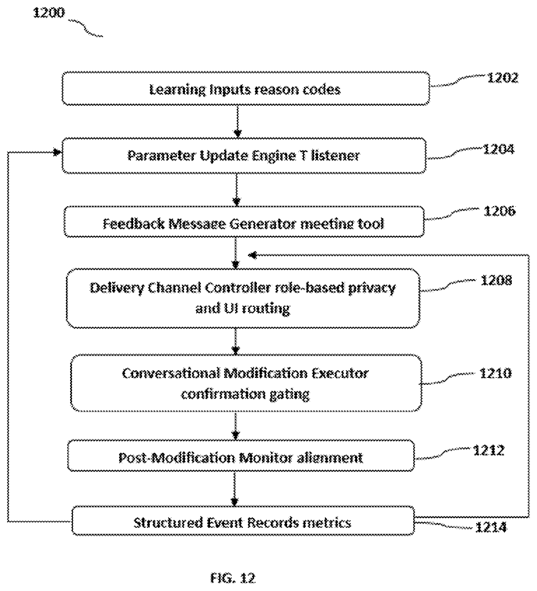

Referring to FIG. 12 illustrates an example learning and adaptation module 1200, according to some embodiments.

The learning and adaptation module 1200 may receive learning inputs 1202 including decision outputs, reason codes, conversational risk outputs, intermediate representations, applied conversational modification strategy identifiers, conversational outcome indicators, and post-modification effectiveness metrics associated with one or more interactions.

The learning inputs 1202 may be provided to a parameter update engine 1204 configured to adaptively update one or more operational parameters of the system. The operational parameters may include listener-specific thresholds T_listener, context-dependent offsets Δ_context, fusion-layer weighting values, machine-learning model parameters, policy parameters associated with strategy selection, personalization profiles, or combinations thereof.

In some embodiments, the parameter update engine 1204 may perform online learning, incremental parameter adjustment, reinforcement learning, policy-gradient optimization, listener-specific fine-tuning, population-level model adaptation, cloud-to-device synchronization, edge-device inference updates, or combinations thereof. The parameter update engine 1204 may utilize historical interaction records, annotated divergence outcomes, post-modification effectiveness metrics, user-specific interaction data, population-level datasets, labeled datasets, unlabeled datasets, synthetic datasets, simulated interaction data, acoustic feature data, affective indicators, environmental context information, network context information, device profile information, rehabilitation program information, or combinations thereof.

The parameter update engine 1204 may generate one or more adaptation outputs provided to a feedback message generator 1206. The feedback message generator 1206 may generate adaptive feedback content for presentation through one or more communication interfaces. The adaptive feedback content may include meeting-tool overlays, wearable-device prompts, companion-application notifications, conversational recap messages, conversational guidance instructions, user-interface modifications, or combinations thereof.

The generated feedback content may be provided to a delivery channel controller 1208 configured to perform role-based privacy enforcement, communication-channel routing, access-control management, channel-specific formatting, or interface-specific adaptation. The delivery channel controller 1208 may selectively route conversational modification instructions to one or more endpoint devices, user interfaces, conferencing systems, hearing-assistance devices, cloud services, or companion systems.

A conversational modification executor 1210 may receive the routed conversational modification instructions and apply one or more conversational modification operations during an active interaction session. The conversational modification operations may include confirmation gating, recap generation, speech-rate advisories, ambiguity-reduction operations, clarification prompting, confirmation-step insertion, articulation guidance, or combinations thereof.

Following application of the conversational modification operations, a post-modification monitor 1212 may evaluate one or more interaction-performance characteristics associated with the modified interaction. The evaluated interaction-performance characteristics may include conversational alignment, response latency, repetition frequency, affective-risk indicators, comprehension metrics, interruption frequency, conversational stability metrics, or combinations thereof.

Structured event records 1214 may be generated based on the monitored interaction outcomes. The structured event records 1214 may include interaction metrics, reason tags, model-version identifiers, integrity metadata, audit information, adaptation history information, policy-selection information, or combinations thereof. The structured event records 1214 may be provided to the parameter update engine 1204 to support closed-loop adaptation, continuous learning, and ongoing refinement of conversational modification policies.

In some embodiments, the closed-loop adaptation process may improve conversational-risk detection accuracy while reducing false positives, oscillatory prompting behavior, unnecessary conversational interventions, repeated prompts, listener fatigue, or interaction instability. Adaptation outputs generated by the learning and adaptation module 1200 may be deployed to hearing devices, cochlear implant accessories, companion devices, conferencing clients, cloud-based services, enterprise workflow systems, or other communication-assistance platforms.

In some examples, the updated parameters may include, without limitation listener-specific thresholds, fusion weights associated with cross-domain signal integration, modification strategy selection policies, listener-specific calibration parameters and model parameters associated with semantic, acoustic, or affective processing modules.

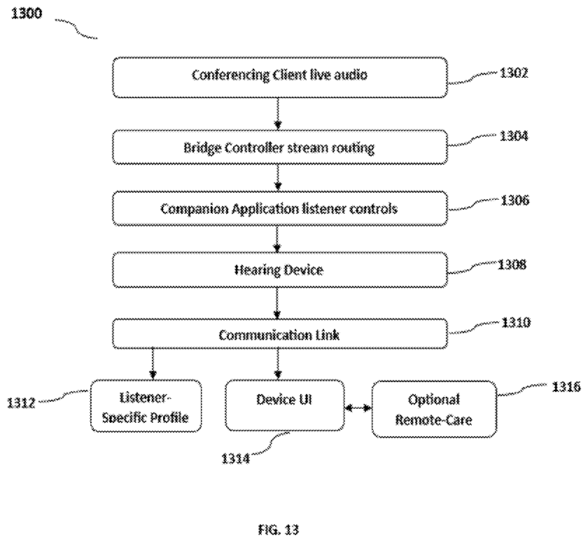

Referring to FIG. 13, a meeting-to-hearing-device bridge architecture 1300 is illustrated. A conferencing client 1302 may provide a live audio stream, caption data, segment identifiers, timestamps, user-interface events, participant identifiers, conversational risk outputs, coherence metrics, intelligibility indicators, and associated interaction metadata generated during a communication session.

The conferencing client 1302 may communicate with a bridge controller stream routing 1304 configured to couple the conferencing environment with one or more companion applications listener controls 1306, such as hearing devices, cochlear implants, hearing-device accessories 1308, or combinations thereof through one or more communication links 1310. The bridge controller stream routing 1304 may perform synchronization operations including timestamp alignment, packet coordination, acknowledgement handling, latency monitoring, retry management, fallback routing, policy enforcement, and listener-assistance orchestration.

In some embodiments, the bridge controller stream routing 1304 couples the conferencing client 1302 or live interaction platform with a hearing device, cochlear implant, companion application, smart-glasses interface, or wearable interface. The bridge controller may route audio data, segment identifiers, timestamp metadata, audio-block pointers, listener-profile parameters, risk outputs, speaker-facing prompts, listener-facing controls, or profile updates between the live interaction platform and the coupled device or application.

In some embodiments, the bridge controller stream routing 1304 synchronizes a difficult-segment identifier with corresponding audio blocks, caption segments, conversational risk metrics, reason tags, listener-specific thresholds, profile references, model-version identifiers, privacy-state information, consent-state information, and user-interface instructions. The bridge controller stream routing 1304 may maintain segment-level association between audio content, metadata, conversational analysis outputs, and user-interface actions using shared timestamps and segment identifiers.

The companion application listener controls 1306 may provide device pairing, local caching, listener controls, profile storage, synchronized replay management, notification routing, consent-state management, and local interaction coordination. In some embodiments, the companion application listener controls 1306 maintains one or more temporary audio buffers or ring buffers configured to retain recent interaction segments for replay, clarification, confirmation, or assisted-hearing operations.

The hearing device, cochlear implant, or hearing-device accessory 1308 may support audio rendering, haptic cues, visual indicators, replay controls, localized acoustic fallback operations, adaptive playback control, speech-enhancement functions, or combinations thereof. In some embodiments, the hearing device or cochlear implant accessory 1308 receives synchronized conversational assistance data associated with one or more identified difficult interaction segments.

The communication link 1310 may include Bluetooth Low Energy (BLE), Wi-Fi communication, wired communication interfaces, hearing-device communication protocols, assistive-listening protocols, cochlear-implant accessory links, operating-system hearing-device interfaces, low-latency streaming interfaces, or combinations thereof.

In certain embodiments, the bridge controller stream routing 1304 maintains separate but synchronized communication channels including: (i) an audio channel carrying live audio or buffered audio blocks; (ii) a metadata channel carrying segment identifiers, timestamps, participant identifiers, conversational risk metrics, reason tags, threshold values, profile references, and model-version identifiers; (iii) a control channel carrying replay, save, acknowledge, dismiss, clarification, haptic, and visual-cue commands; and (iv) an update channel carrying listener-specific threshold updates, playback-parameter recommendations, clinician-authorized settings, adaptation parameters, or combinations thereof.

A listener-specific profile 1312 may store hearing-profile attributes, listener-specific thresholds, playback preferences, language profiles, privacy states, consent states, rehabilitation settings, device capabilities, personalization parameters, adaptation data, or combinations thereof. The listener-specific profile 1312 may be utilized by the bridge controller stream routing 1304 and associated routing components to determine listener-specific assistance behavior, playback policies, and device-specific adaptation operations.

In an embodiment, in a group interaction, the system may receive difficulty signals from multiple listeners or multiple listener-specific profiles. The system may aggregate those signals to select a speaker-directed prompt that improves group-level intelligibility while suppressing listener-identifying information. The system may avoid revealing which listener generated a difficulty signal, which listener replayed or saved a segment, or which listener has a hearing-related profile unless the relevant consent state allows disclosure.

The system may compute an aggregate communication risk or accommodation score using individual listener risk metrics, group-level thresholds, repeated clarification behavior, topic complexity, acoustic conditions, and speaker-specific patterns. The resulting prompt may be a privacy-preserving instruction such as slowing down, defining a term, pausing, providing an example, or reorganizing an explanation.

A device user interface and prompt router 1314 may selectively route conversational assistance outputs to one or more user-interface destinations. The routed outputs may include speaker-only overlays, listener replay interfaces, replay or save controls, companion-application notifications, captioning interfaces, clarification prompts, confirmation prompts, haptic cues, hearing-device cues, visual explanatory-aid indicators, or combinations thereof.

In some embodiments, when a listener replays, saves, marks, or requests clarification for a segment, the system treats the corresponding audio block as difficult audio data. The system may extract acoustic, semantic, contextual, behavioral, or affective features from the corresponding audio block and update thresholds, playback parameters, listener profile parameters, speaker repair strategies, listener aid strategies, model parameters, or fusion weights.

Corresponding audio blocks may be associated with segment identifiers, timestamps, interaction unit identifiers, reason tags, replay indicators, save indicators, speaker prompt identifiers, listener aid identifiers, model version identifiers, and consent states. The system may use audio-block pointers rather than storing full audio in every record.

In some embodiments, routing performed by the device user interface and prompt router 1314 is role-aware and privacy-aware. A speaker-facing interface may present conversational repair instructions including slowing speech rate, defining a term, summarizing content, reducing ambiguity, rephrasing content, or directly answering a detected question. A listener-facing interface may present replay controls, clarification assistance, save functions, captioning assistance, explanatory aids, haptic indicators, visual-cue controls, or combinations thereof associated with a corresponding segment identifier.

An optional remote-care or clinician interface 1316 may provide clinician-authorized settings, threshold updates, playback-parameter recommendations, rehabilitation guidance, device-configuration recommendations, model updates, or combinations thereof.

In some embodiments, the bridge controller stream routing 1304 receives updates from the optional remote-care or clinician interface 1316 and selectively deploys the updates to hearing devices, cochlear implants, companion applications, conferencing clients, or associated communication systems for local application.

In some embodiments, low-latency preprocessing may be performed on a hearing device, cochlear implant, companion device, conferencing client, or client device, while semantic, contextual, affective, fusion, or profile update computations may be performed on a cloud server, remote server, or distributed processing layer. Model parameter updates, listener-specific threshold updates, playback-parameter recommendations, fusion-weight updates, and strategy-policy updates may be transmitted back to local devices for deployment.

During operation, when an interaction-analysis engine identifies a difficult conversational segment, the bridge controller stream routing 1304 may generate an assistance packet associated with the difficult segment. The assistance packet may include at least a segment identifier, start timestamp, end timestamp, audio-block pointer or payload, conversational risk metric, reason tag, listener-specific threshold or profile reference, intended user-interface target, privacy-state information, consent-state information, or combinations thereof. The assistance packet may be transmitted to one or more associated hearing devices, cochlear implants, companion applications, conferencing interfaces, or live-interaction user interfaces.

The bridge controller stream routing 1304 may further implement synchronization and reliability operations including clock alignment, timestamp normalization, packet sequencing, acknowledgement processing, retry logic, latency monitoring, fallback routing, local buffering, and adaptive failover operations. For example, when a low-latency hearing-device communication link becomes unavailable, the companion application listener controls 1306 may retain corresponding audio blocks locally and provide replay or save functionality. Similarly, when remote cloud services become unavailable, locally cached listener thresholds, local acoustic scoring models, local adaptation parameters, or combinations thereof may be utilized to generate limited conversational assistance until remote services are restored.

The meeting-to-hearing-device bridge architecture 1300 provides a synchronized assistive-hearing coordination layer between conferencing systems and hearing-assistance ecosystems. The meeting-to-hearing-device bridge architecture 1300 enables listener-specific conversational assistance, synchronized difficult-segment replay, adaptive conversational repair prompting, hearing-device integration, real-time communication assistance, and coordinated interaction support across distributed communication environments.

In an embodiment, the system may expose difficult-segment outputs through an application programming interface, webhook, event stream, message queue, callback, workflow trigger, profile interface, or synchronization service. Outputs may include difficult-segment identifiers, segment timestamps, audio-block pointers, reason tags, listener-profile offsets, risk scores, replay status, save status, consent state, repair strategy identifiers, or rendered prompt states.

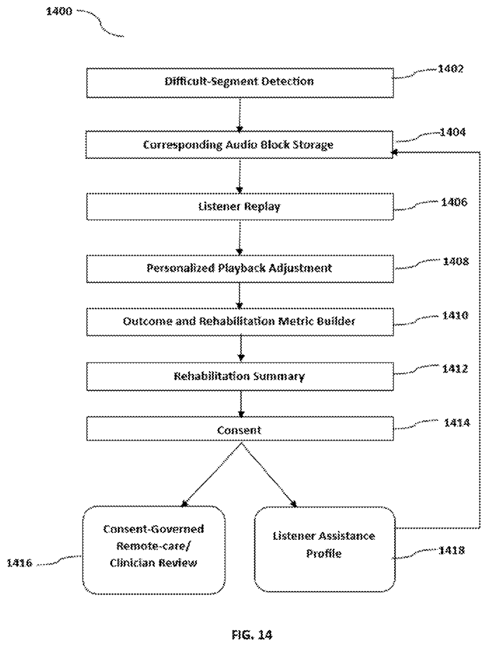

Referring to FIG. 14, an assistive replay, rehabilitation summary, and clinician workflow arrangement 1400 is illustrated.

At step 1402, the system detects a difficult conversational segment using one or more acoustic signals, semantic indicators, behavioral indicators, user-interface or device signals, affective indicators, environmental signals, network conditions, or combinations thereof. The difficult-segment detection may be generated by one or more conversational analysis engines configured to identify conversational divergence, intelligibility risk, comprehension difficulty, affective escalation, or interaction instability conditions.

At step 1404, the system stores, buffers, or references a corresponding audio block and an associated structured interaction event record corresponding to the detected difficult segment. In some embodiments, the corresponding audio block may be obtained from a rolling audio buffer, conferencing-system recording buffer, hearing-device buffer, cochlear-implant accessory buffer, wearable-device buffer, or companion-application buffer. The stored or referenced audio block may correspond to a limited time interval surrounding the difficult segment and may be associated with one or more segment identifiers, timestamps, difficulty indicators, reason tags, selected conversational repair actions, playback parameters, replay indicators, save indicators, privacy attributes, retention attributes, or combinations thereof.

At step 1406, the listener may access replay, save, clarification, or confirmation controls associated with the detected difficult segment. The replay and save controls may include one or more hardware buttons, application soft buttons, wearable gestures, touch commands, voice commands, hearing-device controls, companion-application controls, augmented-reality controls, or other user-interface control mechanisms. In some embodiments, the replay and save interface operates as a listener-controlled assistive function enabling replay of a recent conversational segment, saving of a conversational segment for later review, requesting clarification, or marking a segment as difficult.

At step 1406, playback associated with the difficult segment may be personalized according to one or more listener-specific parameters. The personalized playback adjustment may include modification of playback speed, pitch, volume, gain, caption presentation timing, caption emphasis, explanatory-aid presentation, replay duration, speech enhancement, or combinations thereof based on a listener-specific profile, hearing capability, device profile, rehabilitation program, contextual conditions, or user preferences.

At step 1410, an outcome and rehabilitation metric builder generates one or more replay-centered and difficult-segment-centered metrics associated with listener interaction behavior. The generated metrics may include replay frequency, saved-segment categories, repeated reason tags, difficult-segment counts, response-latency changes, clarification-request trends, reduction in repetition requests, post-modification improvement metrics, playback-parameter changes, listener-threshold changes, interaction-comprehension metrics, or combinations thereof.

In some embodiments, the rehabilitation summary is generated from difficult segment counts, replay frequency, saved audio block categories, repeated difficulty reasons, playback parameter changes, speaker repair prompt effectiveness, listener-specific threshold changes, and improvement in subsequent comprehension outcomes.

The rehabilitation summary, selected audio blocks, de-identified event records, or profile updates may be routed to a remote-care interface, clinician workflow, audiologist review interface, rehabilitation dashboard, caregiver review interface, or accessibility compliance review workflow only when permitted by a consent state, access-control rule, de-identification setting, or privacy policy associated with the listener.

At step 1412, the system generates a rehabilitation summary and updates one or more listener-specific adaptation profiles. The rehabilitation summary may include counts of difficult segments, replay behavior metrics, saved conversational categories, repeated conversational difficulty indicators, environmental or topical difficulty associations, playback-adjustment histories, clarification trends, post-modification effectiveness metrics, listener-threshold updates, or combinations thereof. The rehabilitation summary may be utilized to update a listener-assistance profile, playback-preference profile, training-task profile, rehabilitation-task list, device-setting profile, personalization profile, or combinations thereof.

At step 1414, consent and privacy controls determine whether and how summaries, structured interaction event records, de-identified interaction data, audio excerpts, selected metrics, device-setting recommendations, or combinations thereof may be shared outside a listener-associated device ecosystem. In some embodiments, the system evaluates a consent state, privacy mode, retention rule, access-control rule, permitted-recipient setting, data-governance policy, or combinations thereof before permitting transmission or external access to conversational assistance data.

When sharing is permitted, at 1416, a remote-care or clinician workflow may receive a consent-governed rehabilitation summary, de-identified event records, selected conversational metrics, clinician review tasks, device-setting recommendations, or rehabilitation guidance information. In some embodiments, a clinician interface may generate a rehabilitation task, modify a care plan, recommend hearing-device settings, authorize listener-specific threshold updates, or provide feedback to a listener, caregiver, or rehabilitation provider.

When sharing is not permitted, replay, save, clarification, rehabilitation-summary generation, and profile-update operations may remain local to the listener-associated ecosystem, including a hearing device, cochlear implant accessory, wearable device, companion application, or associated local computing system.

At step 1418, a listener-assistance profile may be updated based on replay behavior, rehabilitation outcome metrics, clinician-authorized settings, playback behavior, interaction trends, user preferences, adaptation metrics, or combinations thereof. The updated listener-assistance profile may include listener thresholds, playback preferences, prompt preferences, rehabilitation settings, personalization parameters, device settings, or combinations thereof.

In some embodiments, the assistive replay and rehabilitation workflow arrangement 1400 remains anchored to difficult-segment detection, corresponding audio-block storage or buffering, replay and save operations, personalized playback adaptation, rehabilitation-summary generation, and hearing-device or companion-device profile adaptation. Clinician-related operations may be implemented as optional consent-governed review and settings-feedback pathways associated with assistive replay functions rather than as a standalone clinical-management workflow.

In some embodiments, calibration of a listener-specific threshold is performed using a training dataset comprising a structured collection of historical and synthetic conversational data used to calibrate and improve model performance. This dataset may include historical interaction units, annotated divergence outcomes, and post-modification effectiveness metrics. The dataset may further incorporate acoustic intelligibility features (speech clarity, noise levels, pitch variation), affective state signals, environment or network context, and listener profile data.

In certain embodiments, one or more conversational risk outputs are exposed to an external application or service through an application programming interface executed locally, remotely, or in a distributed manner. The application programming interface may provide one or more of: a divergence score, an affective risk vector, a composite conversational risk metric, a reason tag, a modification strategy identifier, a trigger status, a threshold value, or a post-modification improvement metric.

In some embodiments, the application programming interface supports real-time or near-real-time streaming delivery, pull-based query access, push notifications, callbacks, webhooks, event streams, message queues, or combinations thereof for delivery of conversational risk outputs.

In some embodiments, an external application receiving conversational risk outputs triggers an automated workflow, notification, escalation routine, meeting-assistance action, training action, accessibility action, or compliance-review process responsive to the received outputs. By way of example, the external application may display a prompt, request clarification, open a guided-assistance panel, generate a follow-up task, route an event for supervisory review, or initiate an intervention protocol.

In some embodiments, the system generates or updates a portable listener intelligibility profile representing how a listener experiences difficulty across speakers, acoustic conditions, speech speed, pitch, volume, vocabulary, topic domains, devices, languages, environments, and interaction formats. The profile may be initialized from a hearing profile, user settings, device type, population-level presets, or cold-start assistance policy and later personalized from replay behavior, save behavior, clarification interactions, manual difficulty indications, response latency, post-intervention outcomes, or clinician feedback.

The portable profile may be stored locally, on a companion device, on a hearing device, in a cloud profile service, or in distributed storage. The profile may be made available through a profile token, application programming interface, synchronization message, device pairing message, or privacy-controlled profile handoff to a hearing device, cochlear implant, companion application, conferencing client, smart-glasses interface, captioning system, contact-center platform, learning platform, cloud service, or assistive communication service.

In an aspect of the invention, the system may be implemented as for portable listener intelligibility profiles, asymmetric dual-sided intervention, replay-to-learning feedback loops, meeting-to-hearing-device bridges, multi-listener privacy-preserving accommodation, consent-governed clinician or rehabilitation review, structured difficult-segment records, difficult-segment APIs, and speaker-specific coaching profiles.

The system may be further implemented as a live communication assistance layer across hearing devices, cochlear implants, companion applications, conferencing clients, contact-center interfaces, smart-glasses interfaces, wearable prompt interfaces, client devices, cloud servers, remote servers, or combinations thereof. The system may operate during live meetings, telephony sessions, online classes, clinical or rehabilitation sessions, customer-support calls, training interactions, or in-person conversations mediated by one or more devices.

1. A computer-implemented method for adaptive conversational intelligibility management during a live interaction between a speaker and one or more listeners, the method comprising:
receiving, by at least one processor, a live audio stream or live audio-visual stream of the interaction;
segmenting the stream into time-bounded interaction units associated with timestamp metadata;
extracting, for a current interaction unit, acoustic intelligibility features and one or more semantic, contextual, behavioral, or affective difficulty signals;
accessing a listener-specific intelligibility profile associated with at least one listener, the profile being derived from at least one of a hearing profile, prior replay behavior, manual difficulty indications, clarification behavior, response latency, device type, environmental context, or prior outcome signals;
detecting a communication-difficulty event for the current interaction unit based on the extracted features, the difficulty signals, and the listener-specific intelligibility profile;
selecting, for the communication-difficulty event, a speaker-directed repair prompt and a listener-directed assistance action;
causing the speaker-directed repair prompt to be presented to the speaker through a speaker-facing user interface, haptic output, aural output, or visual prompt card;
causing the listener-directed assistance action to be presented to the listener through a listener-facing user interface, replay or save control, explanatory aid, caption layer, hearing-device interface, or companion application;
storing or referencing a corresponding audio block associated with the current interaction unit;
monitoring one or more post-intervention outcome signals; and
updating the listener-specific intelligibility profile or an assistance policy based on the outcome signals.

2. The method of claim 1, wherein the communication-difficulty event is detected based on a fusion of acoustic intelligibility features with at least one of semantic divergence, question-answer relevance, topic alignment, terminology density, acronym density, discourse-structure difficulty, contextual inconsistency, overlap, response latency, manual difficulty indication, replay request, or clarification interaction.

3. The method of claim 1, wherein the speaker-directed repair prompt comprises a visual popup, overlay, card, side panel, graphical indicator, or meeting-interface prompt instructing the speaker to slow down, speak more clearly, adjust volume, vary pitch, simplify wording, define a term, provide an example, summarize, pause, answer directly, rephrase, reduce ambiguity, or confirm understanding.

4. The method of claim 3, wherein the visual prompt card includes a concise instruction region, an explanatory or empathetic sentence region, and a control configured to dismiss, acknowledge, request clarification, request replay, save an audio block, or request a next action.

5. The method of claim 1, wherein the listener-directed assistance action comprises private presentation to the listener of a replay control, save control, simplified paraphrase, domain-term gloss, tentative meaning hint, recap, confirmation prompt, caption fallback, translation fallback, visual explanatory aid indicator, or instruction to replay or save the corresponding audio block.

6. The method of claim 1, further comprising generating or updating a portable listener intelligibility profile representing listener-specific difficulty patterns across at least one of speech speed, pitch, volume, terminology density, speaker identity, topic domain, acoustic environment, device type, language, replay behavior, response latency, or clarification behavior.

7. The method of claim 6, further comprising making the portable listener intelligibility profile available to or consumable by a hearing device, cochlear implant, companion application, conferencing client, smart-glasses interface, captioning system, contact-center platform, learning platform, cloud service, or assistive communication service through a profile token, profile interface, application programming interface, synchronization message, or local device storage.

8. The method of claim 1, wherein replaying, saving, or marking the corresponding audio block causes the audio block to be classified as difficult audio data, and wherein the system updates a threshold, profile parameter, playback parameter, speaker repair strategy, listener aid strategy, or model parameter based on the difficult audio data.

9. The method of claim 1, wherein the one or more listeners comprise multiple listeners, and the system aggregates listener-specific difficulty signals or profiles to generate a privacy-preserving speaker-directed prompt without revealing to the speaker which listener generated a difficulty signal or which listener has a hearing-related profile.

10. A distributed system for conversational intelligibility management in a live interaction platform, the system comprising:
one or more microphones or audio interfaces;
one or more client devices, hearing devices, cochlear implants, companion devices, conferencing clients, smart-glasses interfaces, or wearable devices;
one or more processors; and
memory storing instructions that, when executed by the one or more processors, cause the system to:
detect a communication-difficulty event for a time-bounded segment of a live interaction; generate or update at least one participant-specific intelligibility profile;
produce a speaker-directed repair output and a listener-directed support output for the same segment;
store or reference a corresponding audio block for replay or later review;
store a structured interaction event record associated with the segment; and
expose at least one difficult-segment output, audio-block pointer, profile update, repair strategy identifier, or listener-support state to another device, application, or service.

11. The system of claim 10, wherein low-latency preprocessing of the live stream is performed on a hearing device, cochlear implant, companion device, conferencing client, or client device, and wherein one or more semantic, contextual, affective, fusion, or profile-update computations are performed on a cloud server, remote server, or distributed processing layer.

12. The system of claim 10, wherein the structured interaction event record includes one or more of an interaction-unit identifier, timestamp, speaker identifier, listener identifier, device identifier, session identifier, acoustic feature set, semantic feature set, affective risk metric, composite risk metric, threshold value, fusion weight, reason tag, trigger status, repair strategy identifier, rendered instruction, listener-aid identifier, outcome metric, privacy or consent state, model version identifier, corresponding audio-block pointer, replay indicator, save indicator, or integrity metadata.

13. The system of claim 12, wherein the integrity metadata includes an event hash generated over a canonicalized event record, a chain hash linked to a previous event hash, a trusted timestamp, dual local and remote storage metadata, or optional ledger anchoring data, and wherein verification comprises recomputing and comparing one or more hash values.

14. The system of claim 10, wherein the at least one difficult-segment output exposed to another device, application, or service comprises one or more of a difficult-segment identifier, segment timestamp, audio-block pointer, reason tag, listener-profile offset, risk score, replay status, save status, consent state, repair strategy identifier, or rendered prompt state provided through an application programming interface, webhook, event stream, message queue, callback, or workflow trigger.

15. The system of claim 10, wherein a cross-domain fusion layer computes a composite conversational risk metric from at least one acoustic intelligibility feature, at least one semantic or contextual difficulty feature, and at least one behavioral or affective signal, and wherein a dynamic decision engine compares the composite conversational risk metric with a listener-specific threshold or cumulative risk threshold.

16. The system of claim 10, wherein model parameter updates, profile updates, listener-specific threshold updates, playback-parameter recommendations, fusion-weight updates, or strategy-policy updates are transmitted from a cloud server or remote server to a hearing device, cochlear implant, companion application, conferencing client, smart-glasses interface, or client device for local deployment.

17. The system of claim 10, further comprising a bridge controller configured to couple a conferencing client with a hearing device, cochlear implant, companion application, smart-glasses interface, or wearable interface and to route audio data, segment identifiers, timestamp metadata, corresponding audio-block pointers, listener-profile parameters, risk outputs, speaker-facing prompts, or listener-facing controls between the live interaction platform and the coupled device or application.

18. The system of claim 10, wherein the speaker-directed repair output is generated in a privacy-preserving manner so that the speaker receives a behavioral instruction or coaching prompt without receiving a listener identity, diagnostic label, disability status, or private listener profile unless disclosure is permitted by a consent state or access-control rule.

19. A system for assisting verbal communication in a live interaction platform, the system comprising:
one or more microphones or audio interfaces configured to receive speech of a speaker;
one or more processors; and
memory storing instructions that, when executed by the one or more processors, cause the system to:
detect a segment associated with a communication-difficulty event during a conversation between the speaker and a listener based at least in part on acoustic or speech-related features;
provide, for the segment, a speaker-directed repair prompt that requests a change in a way of speaking; present, to the listener, a visual explanatory aid indicator associated with the segment;
store or reference a corresponding audio block associated with the segment; provide replay, save, or clarification controls associated with the corresponding audio block; and
update a participant-specific assistance profile based on subsequent listener interaction with the segment.

20. The system of claim 19, wherein the speaker-directed repair prompt comprises a haptic cue, aural cue, visual indicator, popup card, overlay, side panel, textual instruction, graphical coaching indicator, or meeting-interface prompt indicating that the speaker should slow down, use simpler wording, define a term, add structure, provide an example, pause, rephrase, adjust volume, vary pitch, or reorganize content for the segment.

21. The system of claim 19, wherein the visual explanatory aid indicator presented to the listener includes text indicating a possible intended meaning of the segment, an explanation of a specialized term appearing in the segment, a recap, a confirmation prompt, a simplified paraphrase, a domain-term gloss, or a listener-directed instruction to replay or save the corresponding audio block.

22. The system of claim 19, wherein the system adjusts at least one of playback speed, playback pitch, playback volume, caption presentation, translation presentation, or explanatory-aid presentation for the corresponding audio block based on a hearing capability, listener preference, device profile, environment profile, or rehabilitation program associated with the listener.

23. The system of claim 19, wherein the participant-specific assistance profile includes a portable listener intelligibility profile or a speaker-specific coaching profile, and wherein the profile is updated based on replay frequency, saved segment categories, repeated reason tags, post-intervention outcome metrics, playback-parameter changes, threshold changes, or effectiveness of prior speaker-directed repair prompts.

24. The system of claim 19, wherein the corresponding audio block and associated event metadata are made available to a remote-care interface, clinician workflow, audiologist review interface, rehabilitation dashboard, or caregiver review interface only when permitted by a consent state, access-control rule, de-identification setting, or privacy policy associated with the listener.

25. The system of claim 19, wherein a rehabilitation or accessibility summary is generated from difficult-segment counts, replay frequency, saved audio block categories, repeated difficulty reasons, playback-parameter changes, speaker repair prompt effectiveness, listener-specific threshold changes, or improvement in subsequent comprehension outcomes.

26. The system of claim 19, wherein the system generates a speaker-specific intelligibility or coaching profile indicating patterns in which the speaker's speech is likely to be difficult for one or more listeners or listener-profile categories, and wherein the system uses the speaker-specific profile to adapt future speaker-directed repair prompts.

27. The system of claim 19, wherein, for a group interaction, the system combines difficulty events from multiple listeners or multiple listener-specific profiles to select a speaker-directed prompt that improves group-level intelligibility while suppressing listener-identifying information in the prompt presented to the speaker.

28. A non-transitory computer-readable medium storing instructions that, when executed by one or more processors, cause a communication-assistance system to perform the method of claim 1.

29. The method of claim 1, wherein the listener-specific intelligibility profile is initialized using a cold-start preset assistance policy and is later personalized using replay behavior, clarification interactions, manual difficulty indications, response latency, or post-intervention outcome signals.

30. The system of claim 10, wherein the live interaction platform comprises an online meeting platform, telephony application, mobile device, wearable device, assistive listening device, hearing device ecosystem, cochlear implant ecosystem, contact-center platform, education platform, remote-care platform, companion application, or combinations thereof.
